(19) United States
(12) Patent Application Publication
(10) Pub. No.: US 2004/0081023 A1
(43) Pub. Date: Apr. 29, 2004

(54) Pill container

(76) Inventor: Wai Kwan Ho, Kowloon (HK)

Correspondence Address: LEYDIG VOIT & MAYER, LTD, 700 THIRTEENTH ST. NW, SUITE 300, WASHINGTON, DC, 20005-3960, US

(21) Appl. No.: 10/282,192

(22) Filed: Oct. 29, 2002

(51) Int. Cl. G04B 47/00

(52) U.S. Cl. 368/10

(57) ABSTRACT

A pill container having a body for containing pills, a time/alarm control circuit, and a keypad and a time display connected to the alarm circuit. The keypad includes keys for entering a first pill time and further keys for entering a number of daily medications. The control circuit includes an IC chip for calculating alarm times at regular intervals from the first pill time based on the number of daily medications. The control circuit also provides an audio alarm signal at each of the alarm times.

The present invention relates to a pill container that has a pill alarm function.

### BACKGROUND OF THE INVENTION

For existing pill containers having a pill alarm function, the pill alarms are typically set in the same or similar manner as in the case of normal time alarms. This is inconvenient in practice as pill times do not need to be precise and therefore pills are often taken on the hours for simplicity. Moreover, use has not been made for the fact that persons usually take pills first time for the day in the morning soon after they have got up from bed.

The invention seeks to provide an improved pill container whose pill alarms can be set relatively easier or more conveniently.

### SUMMARY OF THE INVENTION

According to the invention, there is provided a pill container comprising a body for containing pills, an alarm/time control circuit housed in the body, and a keypad and a time display supported by the body and connected to the alarm circuit. The keypad includes first keying means for entering a first pill time and second keying means for entering a number of daily medications. The control circuit includes calculating means for calculating alarm times at regular intervals from the first pill time based on the number of daily medications and alarm means for providing an audio alarm signal at each of the alarm times.

Preferably, the first keying means comprises a key for incrementally increasing the time on the display from a predetermined morning time by a fixed period.

More preferably, the predetermined morning time is 6:00 am.

It is preferred that the fixed period is one hour.

It is further preferred that the first keying means includes another key for increasing the time on the display by 30 minutes.

Preferably, the first keying means includes a designated key for entering the time on the display as the first pill time.

In a preferred embodiment, the second keying means comprises a plurality of keys, each representing a corresponding number of daily medications.

More preferably, the alarm times calculated based on the numbers of daily medications fall within the normal awake hours of a person.

Further more preferably, the keys represent one, two, three and four daily medications respectively.

Yet further more preferably, the alarm times calculated based on two, three and four daily medications are spread over substantially the same total period.

It is preferred that the alarm times calculated based on some of the numbers of daily medications cover 24 hours a day.

It is further preferred that said some numbers of daily medications comprise three and four.

Preferably, the second keying means includes a key representing one daily medication at a predetermined bedtime.

More preferably, the predetermined bedtime is 9:00 pm.

It is preferred that the time display includes an icon arranged to represent corresponding alarm times by reference to the number of daily medications based on which the alarm times are calculated.

It is preferred that the second keying means includes a first designated key for reviewing the alarm times based on each number of daily medications, and a second designated key for cancelling alarm times based on a number of daily medications selected by the corresponding one of the plurality of keys representing that number of daily medications.

In a specific construction, the body comprises a base for containing pills and a lid housing therein the alarm control circuit and supporting thereon the keypad and the time display.

More specifically, the base is partitioned into a plurality of compartments for containing pills, and includes a plurality of inner lids for closing the compartments.

### BRIEF DESCRIPTION OF DRAWINGS

The invention will now be more particularly described, by way of example only, with reference to the accompanying drawing, in which:

FIG. 1 is a top plan view of an embodiment of a pill container in accordance with the invention, said container having a lid incorporating a keypad and a display;

FIG. 2 is a front perspective view of the pill container of FIG. 1, that is opened;

FIGS. 3A to 3C are sequential schematic diagrams of the keypad and display of FIG. 1, illustrating how the first pill time is set;

FIGS. 4A to 4D are sequential schematic diagrams of the keypad and display of FIG. 1, illustrating how daily pill alarms are set for 2-times, 3-times and before-sleep;

FIGS. 5A to 5C are schematic diagrams of the display of FIGS. 4A to 4D, illustrating set off of the pill alarms for 2-times, 3-times and before-sleep respectively; and

FIGS. 6A to 6D are sequential schematic diagrams of the keypad and display of FIG. 1, illustrating how daily pill alarms for 3-times and before-sleep are cancelled.

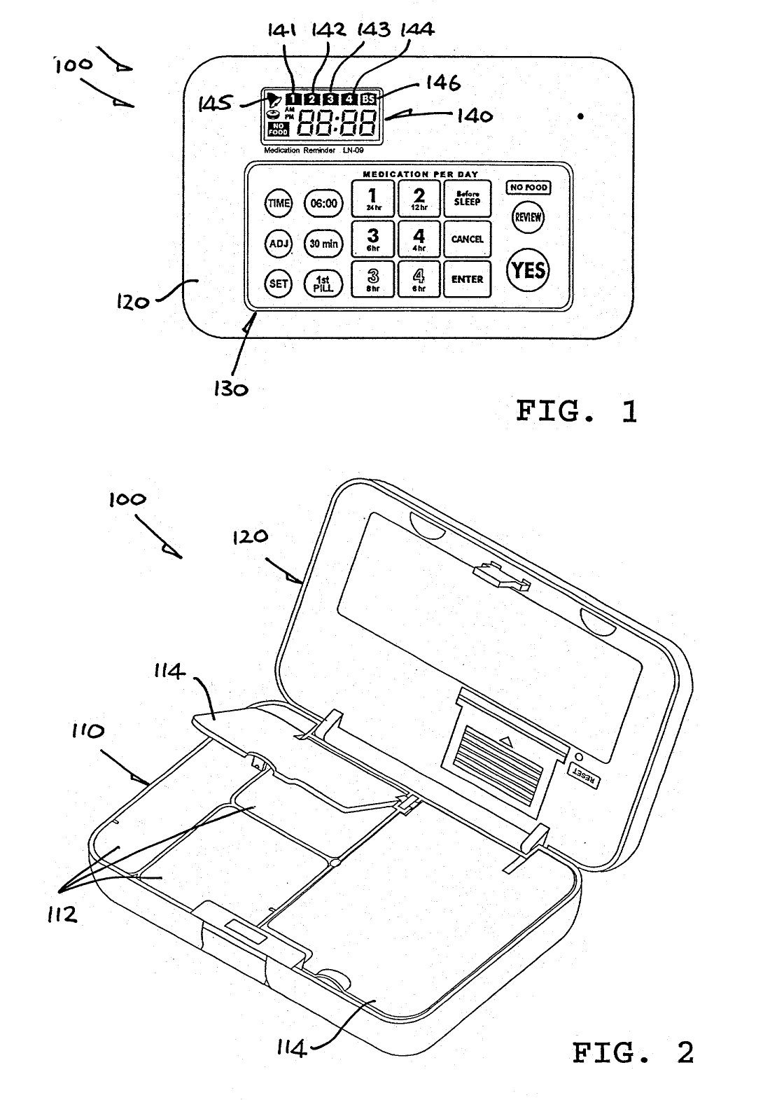

### DETAILED DESCRIPTION OF PREFERRED EMBODIMENT

Referring to the drawings, there is shown a pill container or box 100 embodying the invention, which box 100 is generally flat rectangular and comprises a base 110 and a hinged top lid 120 for closing the base 110. The base 110 is partitioned into three compartments 112 on each left/right side for containing different pills, and includes a pair of left and right inner lids 114 for closing the compartments 112 on the corresponding sides.

The top lid 120 is hollow, and houses therein an electronic control circuit that is implemented based on an alarm/time IC chip for general time and alarm keeping and in particular calculating alarm times. The control circuit includes a RAM memory for storing time and alarms and an audio generator for providing alarm and beep sounds. The lid 120 supports, on its outer surface, a soft-touch keypad 130 and a LCD time display 140, both of which are connected to and whose operation is controlled by the control circuit.

The keypad 130 is for setting normal clock time and daily pill alarm and related functions, having the following keys:

A. “TIME”, “ADJ” and “SET” keys for setting the normal clock time

B. “06:00”, “30 min” and “1st PILL” keys for setting the first pill time

C. “1”, “2”, “3”, “4”, “ [symbol] ”, “ [symbol] ”, “Before SLEEP” and “NO FOOD” keys for setting daily pill alarms

D. “ENTER”, “REVIEW” and “CANCEL” keys for entering, reviewing and cancelling daily pill alarms

E. “YES” key for turning off pill alarms

The display 140 is for displaying the normal clock time and daily medication alarms, and includes certain icons as, shown. Apart from an alarm bell icon 145, there are four pill alarm icons 141 to 144 that represent alarms for 1-time to 4-times medications per day by reference to or using the numbers of daily medications of one to four respectively. Another icon 146 “BS” is also included for the daily pill alarm for pill taking before sleep.

To initialise the pill box 100 for use, the normal clock time is set on the display 140 using the “TIME”, “ADJ” aid “SET” keys in a way that is generally known in the art. For example, the “TIME” key selects the hour and minute, the “ADJ” key adjusts the hour and minute digits incrementally, and the “SET” key confirms the time set.

FIGS. 3A to 3C illustrate how the first pill time is set at 08:30 (8:30 am) for example, when the first pill(s) should be taken. The “06:00” key is used to advance time by hours, which upon initial depression calls up 06:00 on the display 140 and upon two more depressions advances the displayed time from 06:00 to 08:00 (FIG. 3A), with the alarm bell icon 145 blinking. The first pill time can only be set in the range from 6:00 am to 11:30 am. The start of 6:00 am is factory set as the earliest possible morning time that a person normally wakes up and takes pills. The “30 min” key is then pressed to advance the displayed time by 30 minutes to 08:30 (FIG. 3B). The “1st PILL” key is finally hit to confirm the first pill time (FIG. 3C), whereupon the alarm bell icon 145 will stay on without blinking and a beep sound is given.

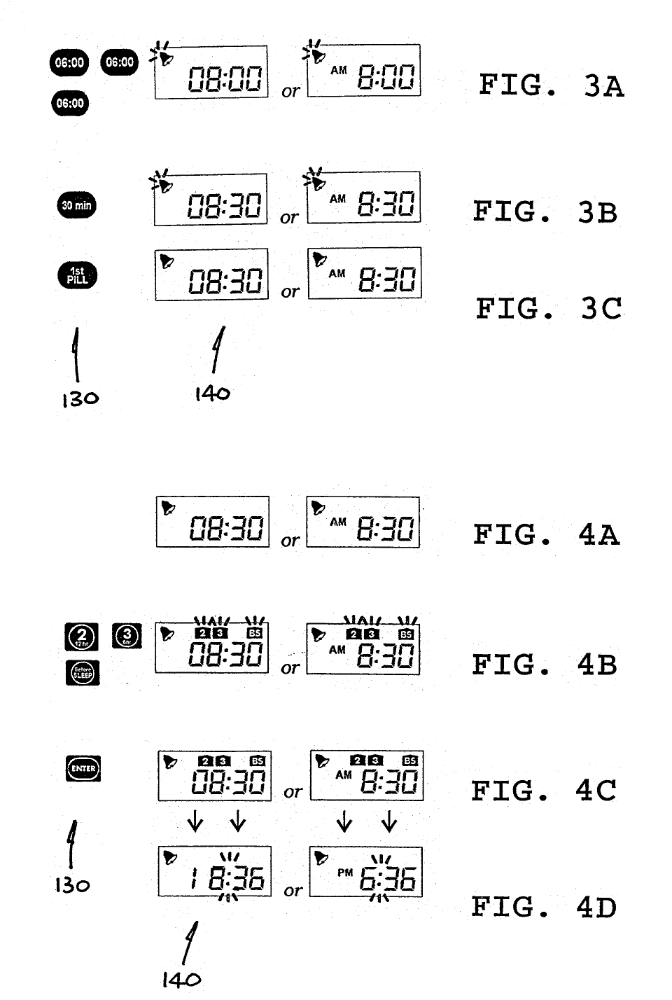

FIGS. 4A to 4C illustrate how 2-times, 3-times and before-sleep daily medication alarms are set for three different pills, which can only be done while the first pill time is set and remains on the display 140 (FIG. 4A) that applies to all pills. Alarms should be set in 10 minutes after the first pill time has been set, otherwise the display 140 will return to the normal time display mode.

The 2-times alarm is for the pill that should be taken two times a day, and is set by pressing the “2” key. Subsequent pressing of the “3” key sets the 3-times alarm for another pill. The “Before SLEEP” key is then hit to set a daily alarm at a predetermined bedtime such as 21:00 (9:00 pm) for the remaining pill that should be taken only once a day and just before the person sleeps, which is predetermined and is independent of the first pill time.

Upon pressing of these keys (FIG. 4B), the associated pill alarm icons “2”, “3” and “BS” will blink on the display 140 as shown to indicate the selections. Finally, hitting of the “ENTER” key confirms and thus enters all three alarm settings, with the associated icons stopping blinking and a beep sound given (FIG. 4C). The display 140 will return to the normal time display mode (FIG. 4b) in about 30 seconds or sooner upon hitting of the “TIME” key.

The “1” and “4” keys can also be used in the same manner to set the 1-time and 4-times daily alarms respectively for other pills. The “1” key is for one medication per day at the first pill time.

The “NO FOOD” key may be pressed if necessary, while a particular daily pill alarm is being set, to provide warning signals one hour before and one hour after the pill alarm is due each time. The warning signals indicate that no food is allowed within these two hours, for pills that should be taken without food.

In general, the pill alarm times calculated based on the “2” to “4” keys are for medicines that should be taken at regular intervals during the normal awake hours of a person, i.e. from morning to evening and excluding the usual sleeping hours.

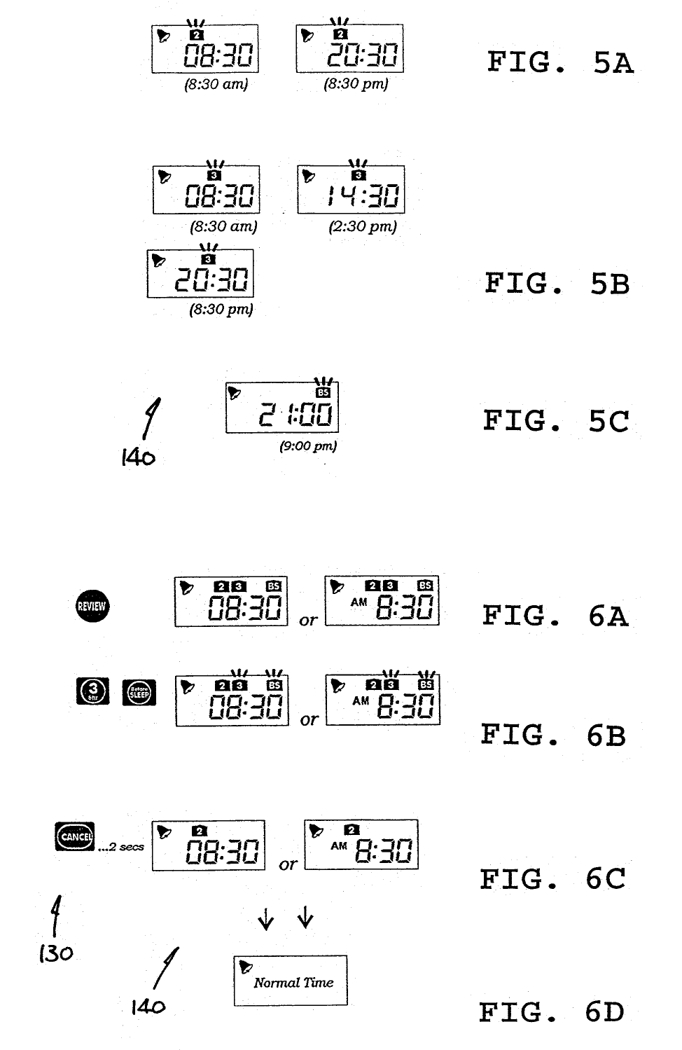

The “2” key is used to remind for medications twice a day at, 12 hours apart, such as 08:30 and 20:30, at which times the corresponding alarms will set off with the pill alarm icon “2” flashing on the display 140 (FIG. 5A). The “3” key is for medications three times a day at 6 hours apart, such as 08:30, 14:30 and 20:30 (FIG. 5B), likewise spreading over a total period of 12 hours (6 hours×2). The time interval associated with the “4” key is 4 hours, and the total medication period is also 12 hours (4 hours×3).

For medication only once a day before sleep, the alarm will set off at 21:00 with the “BS” pill alarm icon flashing (FIG. 5C). For all pill alarms, while an alarm with beeps is on, the relevant pills should be taken, and the “YES” key is used to turn off the alarm, stopping the beeps and cancelling the relevant pill alarm icon. If the “YES” key is not pressed, the beeps will stop in 14 minutes, but the pill alarm icon will continue flashing until the next alarm time.

Normally, a person is only required to take medicines when he or she is awake. For certain medicines that need to be taken regularly around the clock, the “ [symbol] ” and “ [symbol] ” keys can be used. The alarm times calculated based on these two keys cover 24 hours a day, with the “ [symbol] ” key providing three alarms at 8 hours apart (8 hours×3) and the “ [symbol] ” key providing an alarm every 6 hours (6 hours×4).

Upon completion of a medication cycle, or when a specific medication alarm is no longer in need, the relevant alarms can be cancelled, as illustrated in FIGS. 6A to 6D for 3-times and before-sleep daily alarms. The “REVIEW” key is first hit to show all the alarms stored in the memory on the display 140 by their icons, i.e. “2”, “3” and “BS” as shown (FIG. 6A). The “3” and “Before SLEEP” keys are then pressed to select these two alarms, resulting in their associated icons “3” and “BS” flashing (FIG. 6B). The “CANCEL” key is finally pressed and held for 4 seconds until the flashing icons disappear, whereupon both alarms are cancelled with a beep sound given (FIG. 6C), leaving only the 2-times pill alarm effective. The display 140 will return to the normal time display mode (FIG. 6D) in about 30 seconds.

All the set alarms cannot be cancelled unless the above procedures are followed, whereby accidental cancellation of the alarms, for example by hitting any single key or more than one key at random, is prevented.

For pills that need to be taken in different medication cycles, the compartments 112 of the pill container 100 may be labeled for the pills according to their numbers of medications per day.

The invention has been given by way of example only, and various modifications of and/or alterations to the described embodiment may be made by persons skilled in the art without departing from the scope of the invention as specified in the appended claims.

1. A pill container comprising a body for containing pills, an alarm/time control circuit housed in the body, and a keypad and a time display supported by the body and connected to the alarm circuit, the keypad including first keying means for entering a first pill time and second keying means for entering a number of daily medications, the control circuit including calculating means for calculating alarm times at regular intervals from the first pill time based on the number of daily medications and alarm means for providing an audio alarm signal at each of the alarm times.

2. The pill container as claimed in claim 1, wherein the first keying means comprises a key for incrementally increasing the time on the display from a predetermined morning time by a fixed period.

3. The pill container as claimed in claim 2, wherein the predetermined morning time is 6:00 am.

4. The pill container as claimed in claim 2, wherein the fixed period is one hour.

5. The pill container as claimed in claim 4, wherein the first keying means includes another key for increasing the time on the display by 30 minutes.

6. The pill container as claimed in claim 2, wherein the first keying means includes a designated key for entering the time on the display as the first pill time.

7. The pill container as claimed in claim 1, wherein the second keying means comprises a plurality of keys, each representing a corresponding number of daily medications.

8. The pill container as claimed in claim 7, wherein the alarm times calculated based on the numbers of daily medications fall within the normal awake hours of a person.

9. The pill container as claimed in claim 8, wherein the keys represent one, two, three and four daily medications respectively.

10. The pill container as claimed in claim 9, wherein the alarm times calculated based on two, three and four daily medications are spread over substantially the same total period.

11. The pill container as claimed in claim 7, wherein the alarm times calculated based on some of the numbers of daily medications cover 24 hours a day.

12. The pill container as claimed in claim 11, wherein said some numbers of daily medications comprise three and four.

13. The pill container as claimed in claim 7, wherein the second keying means includes a key representing one daily medication at a predetermined bedtime.

14. The pill container as claimed in claim 13, wherein the predetermined bedtime is 9:00 pm.

15. The pill container as claimed in claim 1, wherein the time display includes an icon arranged to represent corresponding alarm times by reference to the number of daily medications based on which the alarm times are calculated.

16. The pill container as claimed in claim 7, wherein the second keying means includes a first designated key for reviewing the alarm times based on each number of daily medications, and a second designated key for cancelling alarm times based on a number of daily medications selected by the corresponding one of the plurality of keys representing that number of daily medications.

17. The pill container as claimed in claim 1, wherein the body comprises a base for containing pills and a lid housing therein the alarm control circuit and supporting thereon the keypad and the time display.

18. The pill container as claimed in claim 17, wherein the base is partitioned into a plurality of compartments for containing pills, and includes a plurality of inner lids for closing the compartments.
